(19) United States
(12) Patent Application Publication
(10) Pub. No.: US 2009/0242470 A1
(43) Pub. Date: Oct. 1, 2009

(54) FILTER CLOSURE SYSTEM WITH BAYONET CLOSURE

(75) Inventors: Karlheinz Muenkel, Oberderdingen-Flehingen (DE); Klemens Dworatzek, Edingen (DE); Thomas Petschl, Ludwigsburg (DE); Stefan Becker, Speyer (DE); Duc Cuong Nguyen, Laatzen (DE)

Correspondence Address: Mann+Hummel GMBH, Dept: VR-P Plant 5.4, Hindenburgstr. 45, Ludwigsburg, 71638, DE

(73) Assignee: MANN+HUMMEL GMBH, Ludwigsburg (DE)

(21) Appl. No.: 12/412,637

(22) Filed: Mar. 27, 2009

(30) Foreign Application Priority Data
Mar. 27, 2008 (DE) 202008004289.5

(51) Int. Cl. B01D 29/00; B01D 21/30

(52) U.S. Cl. 210/148; 210/236

(57) ABSTRACT

A filter closure system has a connecting end at an end face of a cylindrical filter housing and a connecting head matching the connecting end. The connecting end is insertable axially into the connecting head and connected positive-lockingly to the connecting head by an insertion-rotation movement. Connecting end and connecting head have a bayonet connection with receiving slots or receiving projections and matching insertion projections. The matching insertion projections engage the receiving slots or projections when the bayonet connection is closed. The receiving slots or projections and the insertion projections each are arranged substantially in a perpendicular plane relative to the insertion direction. The receiving slots or projections are elongate and circumferentially do not extend completely around but are segmented. The receiving slots or projections are sequentially arranged in the insertion direction and are substantially parallel to one another. The insertion projections are also sequentially arranged in the insertion direction.

### CROSS REFERENCE TO RELATED APPLICATIONS

This application claims the benefit under 35 USC 119 of the earlier filing date of foreign application DE 20 2008 004 289.5 filed in Germany on Mar. 27, 2008.

### TECHNICAL FIELD

The invention relates to filter housing and filter closure systems for filter housings.

### BACKGROUND OF THE INVENTION

The invention relates to a filter closure system for seal-tightly connecting a connecting end at the end face of a of circular cylindrical shaped filter housing to a connecting head that matches the connecting end and into or onto which the connecting end is insertable or attachable in an axial insertion direction and, by an insertion-rotation movement, is connectable positive-lockingly to the connecting head. The connecting end and the connecting head have at least at one connecting location a bayonet connection. The bayonet connection in or on one of the two connected parts includes a receiving slot or a receiving projection that is arranged substantially in a plane extending perpendicularly to the insertion direction, that is elongate and that, in the circumferential direction, does not extend completely around but, for enabling the insertion or attachment, is segmented and interrupted. The bayonet connection on the other connected part includes an insertion projection that matches the receiving slot or receiving projection and that engages the receiving slot or receiving projection when the bayonet connection is closed.

The filter closure system serves for producing a pressure-tight and/or gas-tight and/or liquid-tight connection between the filter housing and the connecting head. The invention is also directed to filter closure systems that are provided for mounting a filter or filter housing of the disposable type as well as those where the filter or filter housing is regularly replaced for maintenance or repair work.

A preferred field of application of such filter closure systems is with stationary and movable compressed air devices. The compressors used in this connection generate a pressure of up to approximately 20 bar, typically approximately 7 to 8 bar, and require oil for lubrication, for sealing and for cooling of the moving parts so that oil-containing gases are produced. Per cubic meter of air approximately 5 liters of oil are injected into the screw-type compressor; removing oil from the compressed air is thus an important measure. In order to recover most of this oil and in order to purify the compressed air by removing the oil, oil recovery elements are used that must be regularly exchanged during maintenance work on the device. These oil-removing elements are the filter elements of an appropriate filter and are arranged in a filter housing. The filter medium is in most cases a wound filter or coalescencing filter. The filters or filter elements that are inserted into the filter housing are usually disposable parts because the filter elements not only separate oil that is to be returned into the oil circulation of the compressed air device for reuse but, over the course of time, they become clogged by the deposited dirt particles. The same application of such oil removal elements or oil separators is provided in vacuum pumps.

Other applications of such filter closure systems are found in connection with liquid filters that remove dirt particles or other components from a liquid, for example, oil filters, fuel filters, hydraulic liquid filters, cooling medium filters, water separators or process filters for removing large amounts of contaminants from process liquids, in particular, in case of grinding, eroding or electrical discharge machining processes. Filter closure systems are also used in liquid separators that separate liquid or solid contaminants from a gas stream, in particular, in internal combustion engines, for example, for cleaning oil-containing venting gases of the crankcase.

In areas such as oil filtration and removal of oil from air, the filter closure system must particularly satisfy the requirements in respect to pressure resistance and temperature resistance. Important features are also a simple, self-evident handling that prevents faulty operation and a cost-efficient production and/or disposal.

Filter closure systems established in the art are primarily based on threaded connections. In such systems a filter housing, provided generally with a centrally arranged thread that is located on a terminal disk inserted into the filter housing, is screwed onto a matching threaded socket of the connecting head and by means of a sealing device, for example, an O-ring, a sealing action is achieved. Moreover, bayonet closures are known.

Based on these known devices, it is the object of the invention to provide a filter closure system in which in a simple way a seal-tight connection can be produced that enables a simple, self-evident manipulation preventing faulty operation and that is cost-efficient with regard to production and/or disposal.

### SUMMARY OF THE INVENTION

In accordance with the present invention, the bayonet connection comprises several receiving slots or receiving projections, sequentially arranged in the insertion direction and arranged substantially in parallel planes extending perpendicularly to the insertion direction, as well as several matching insertion projections.

The filter closure system according to the invention for seal-tightly connecting a connecting end at the end face of a circular cylindrical filter housing to a connecting head matching the connecting end, wherein into or onto said connecting head the connecting end is insertable or attachable in an axial insertion direction and is connectable by an insertion-rotation movement positive-lockingly to the connecting head. In this connection, the connecting end and the connecting head comprise on at least one connecting location a bayonet connection that comprises in or on one of the two connected parts a receiving slot or a receiving projection that is arranged substantially in a plane perpendicular to the insertion direction, is elongate and, in the circumferential direction, does not extend completely around but, for enabling the insertion or attachment, is segmented and interrupted. The bayonet connection comprises on the other connected part an insertion projection that matches the receiving slot or receiving projection and that engages the receiving slot or receiving projection when the bayonet connection is closed. The filter closures system according to the invention has the special feature that the bayonet closure has several sequentially arranged receiving slots or receiving projections in the insertion direction that are arranged substantially in parallel planes that extend perpendicularly to the insertion direction and further has several matching insertion projections.

Stated more simply, a filter closure system is proposed that could be referred to as a multi-row bayonet closure in contrast to the prior art where only single-row bayonet closures are known.

The filter closure system according to the invention has the advantages that in a simple way a seal-tight connection can be produced wherein a simple, self-evident handling is enabled that also prevent operating errors. Moreover, the production and/or disposal can be realized in an inexpensive way. Further advantages of the invention reside in the great load capacity and holding force of the high-strength connection that can be achieved even with minimal mounting forces; a fast mounting and demounting action because, in contrast to conventional screw-on filters, it is not required to perform several turns of the filter for screwing it on or off; the application of the closure system in a very tight space and at minimal cost; and the realization of advantageous metal-free configurations for disposal of used filters including filter housing, filter element and closure system.

Since, in contrast to the prior art devices, there is no need for a stable terminal disk, i.e., a disk made from metal, with a centrally arranged thread at the end face of the filter in order to screw on the filter onto a threaded socket of the connecting head, it is possible to produce metal-free filters in accordance with the present invention. Therefore, it is possible to design the terminal disks to be significantly weaker, i.e, thinner and/or made from plastic. This is so because the force flow between the filter housing and the connecting head, i.e., the force introduction between these two parts for producing the mechanical connection is improved by a multi-row bayonet closure positioned farther outwardly on the filter housing in comparison to a central thread. Thus, the entire filter, comprising the filter housing and the filter element arranged therein as well as the terminal disk of the filter at the end face, can be produced to be free of metal.

A further advantage in case of a metal-free embodiment is that the plastic parts can be manufactured with less expenditure and great purity in comparison to metal parts. Metal parts have residues in the form of cuttings, oil, and welding residues that must be removed by means of complex cleaning procedures; this entails the risk that residues still remain. In contrast, plastic parts can be produced as very clean parts by injection molding processes without such residues remaining thereon.

A further advantage of the closure system according to the invention resides in that by the exterior bayonet closure the terminal disk at the face can be designed freely for supply and removal of the fluids. In this way, the flow conditions in the filter and the separation action of the filter can be improved and pressure loss can be reduced.

Preferred embodiments and modifications of the invention can be taken from the dependent claims and the following description and drawings. The special features disclosed in the following can be used individually or in combination with one another in order to create preferred embodiments of the invention.

### BRIEF DESCRIPTION OF THE DRAWINGS

The accompanying Figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

Features of the present invention, which are believed to be novel, are set forth in the drawings and more particularly in the appended claims. The invention, together with the further objects and advantages thereof, may be best understood with reference to the following description, taken in conjunction with the accompanying drawings. The drawings show a form of the invention that is presently preferred; however, the invention is not limited to the precise arrangement shown in the drawings.

FIG. 1 shows a perspective partially sectioned view of a prior art filter and connecting head;

FIG. 2 shows a perspective view of a filter according to the invention with a connecting head before mounting of the filter on the connecting head, consistent with the present invention;

FIG. 3 is an elevation view showing the parts of FIG. 2 after mounting;

FIG. 4 is a section view A-A of FIG. 3;

FIG. 5 is a section view B-B of FIG. 4;

FIG. 6 is a perspective detail view of the closure system according to the invention;

FIG. 7 shows the connecting end of FIG. 6;

FIG. 8 shows the connecting head of FIG. 6; and

FIG. 9. depicts a schematic representation of a filter closure system in which the securing device includes an electric signal transducer to emit a signal when the filter housing is opened.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of apparatus components related to filter closure systems. Accordingly, the apparatus components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

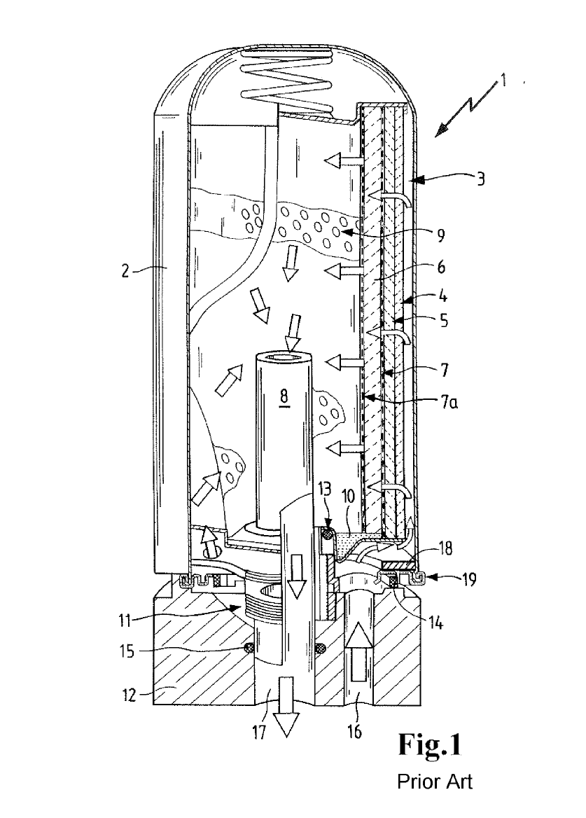

FIG. 1 shows a filter 1 according to the prior art that is provided as a screw-on filter or a so-called spin-on filter used as an oil separator in a device for producing compressed air. The filter 1 comprises a pressure-resistant circular cylindrical filter housing 2 that is comprised of plastic material or metal and is configured as a filter cup or filter pot. In the filter housing 2 there is a filter element 3 through which fluid passes radially from the exterior to the interior so that oil is removed from the fluid. In the illustrated embodiment the filter element 3 comprises a pre-separator 4, a fine separator 5, and an after-separator 6.

Moreover, in the filter 1 there are two pressure-stable support tubes 7, 7a and a removal socket 8 that provides for spatial separation of the removal locations for the compressed air 9 from which oil has been removed and for the separated oil 10. The separated oil 10 drains in the filter 1 into an oil sump, is sucked away by a drainage connector, and is returned to the oil circulation of the compressed air device. The drainage connector for removal of separated oil 10 from the oil sump is not illustrated.

The filter 1 is seal-tightly connected by means of a central axial screw-on nipple 11 to the connecting head 12 of the compressed air device. For radial and axial sealing actions three seals in the form of O-rings 13, 14, 15 are provided. One or several seals, in particular seal 14, can be designed as a seal of rectangular cross-section. The connecting head 12 has an outlet 16 for the air/oil mixture to be purified which mixture enters the filter 1 through an appropriate opening and passes through the filter element 3 radially from the exterior to the interior as well as an inlet 17. By means of the removal socket 8 the compressed air from which oil has been removed is returned from the filter 1 by means of inlet 17 into the compressed air device.

The end face of the filter housing 2 is formed by a terminal disk 18 that is stable and made from metal and is connected by crimping 19 to the filter housing 2.

The filter 1 illustrated in FIG. 1 is a so-called upright variant in which the filter 1 is arranged above the connecting head 12. The reverse arrangement in which the filter 1 is arranged below the connecting head 12 is referred to as suspended variant. The difference is substantially that it comprises a conduit for removal of oil from the oil sump which conduit passes through the filter 1 across its axial length.

In some embodiments it can be provided that upon exchanging the filter only the filter element 3 is to be exchanged and the filter housing 2 is to be reused. In other embodiments, the filter housing 2 and the filter element 3 inserted therein form a unit representing together a disposable part.

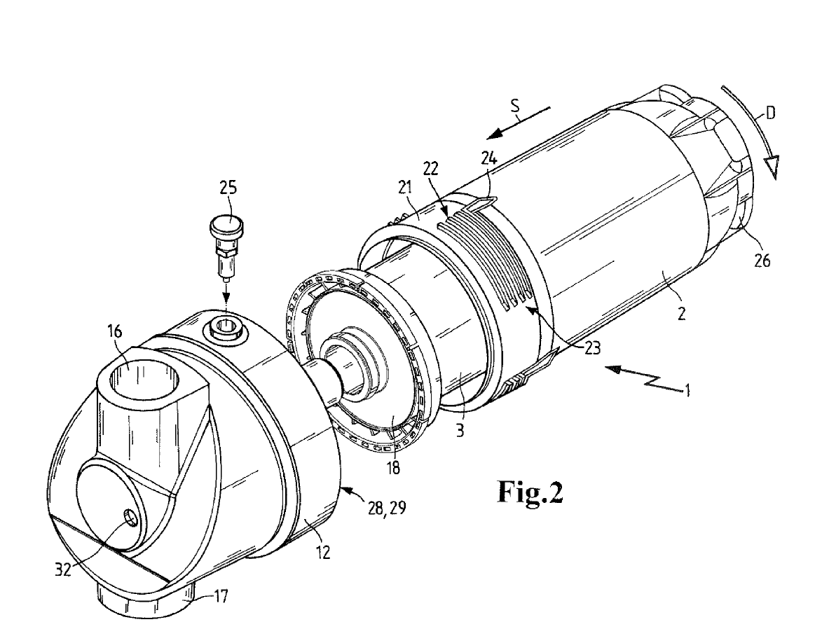

In FIG. 2, a filter 1 in accordance with the present invention is illustrated that differs from the prior art device mainly in regard to the filter closure system for seal-tightly connecting the connecting end 21 at the end face to the connecting head 12 that matches the connecting end 21. In this connection, the filter element 3 and the terminal disk 18 can be designed differently.

The filter housing 2 is insertable or attachable in axial insertion direction S into or onto the connecting head 12 and can be positive-lockingly connected by an insertion-rotation movement to the connecting head 12. The rotational direction D for mounting the filter housing 2 is illustrated by an arrow. The connecting end 21 and the connecting head 12 have at least at one connecting location a bayonet connection or bayonet closure that comprises in one of the two connected parts, which in the illustrated embodiment is the connecting head 12, a receiving slot or a receiving projection that is arranged substantially in a plane perpendicular to the insertion direction S, is elongated and, in the circumferential direction, does not extend completely around but, is segmented and interrupted for enabling insertion or attachment. By substantially in a plane perpendicular to the insertion direction S we mean that the a receiving slot or a receiving projection may be positioned and aligned precisely in the perpendicular plane, or the receiving slot or a receiving projection may be positioned at a slant relative to the perpendicular plane such that the receiving slot or a receiving projection has a positive or negative pitch, as discussed later below.

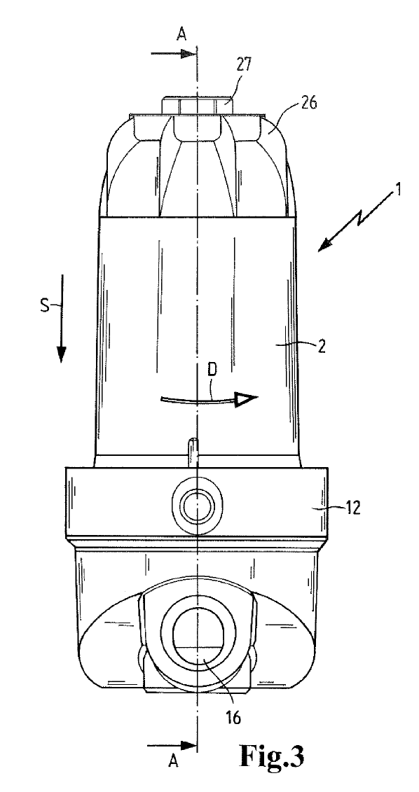

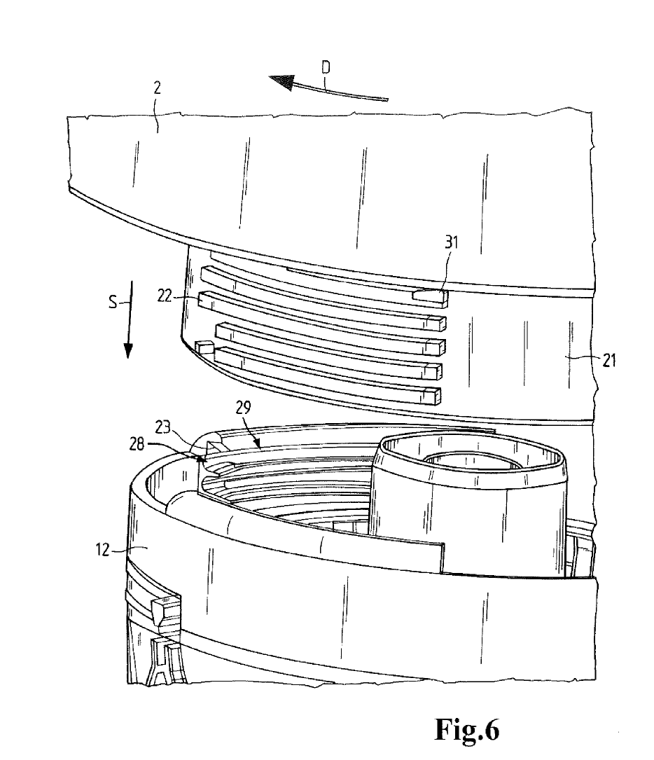

The bayonet connection comprises on the other connected part (in the illustrated embodiment of FIG. 3 this is the filter housing 2) an insertion projection 22 that matches the receiving slot 28 (see FIG. 6) or receiving projection 29 (see FIG. 6) and that engages the receiving slot or receiving projection when the bayonet connection is closed. The embodiment according to the invention of the filter closure system has the special feature that the bayonet connection has several receiving slots or receiving projections sequentially arranged in the insertion direction S that are arranged substantially in parallel planes perpendicularly to the insertion direction S as well as several matching insertion projections 22. The closure system is thus a multi-row bayonet closure that comprises a rib structure with several parallel ribs that are formed by the parallel insertion projections 22 and matching receiving slots 28 (see FIG. 6) or receiving projections 29 (see FIG. 6). By substantially in a plane perpendicular to the insertion direction S we mean that the a receiving slot or a receiving projection may be positioned and aligned precisely in the perpendicular plane, or the receiving slot or a receiving projection may be positioned at a slant relative to the perpendicular plane such that the receiving slot or a receiving projection has a positive or negative pitch, as discussed later below.

The insertion projections 22 are elongated, i.e., they extend in the circumferential direction of the filter housing 2 or of the connecting head 12 and are interrupted by segmentation. The number of insertion projections 22 extending in a plane perpendicular to the insertion direction along the circumference of the filter housing 2 or of the connecting head 12 sequentially behind one another may be advantageously between two and ten, preferably between three and five. The total length of the insertion projections 22 extending in a plane perpendicular to the insertion direction along the circumference of the filter housing 2 or of the connecting head 12 is advantageously between 5% and 90%, preferably between 10% and 80%, particularly preferred between 30% and 70%, of the circumference of the filter housing 2 or of the connecting head 12.

In the embodiment illustrated in FIG. 2 the connecting end 21 is arranged radially inwardly relative to the connecting head 12 such that the connecting head 12 radially engages externally the connecting end 21. This embodiment is preferred because the connecting seams, adhesive seams or welding seams in the filter 1 or the terminal disk 18 are exposed to a more beneficial pressure loading and because the inner pressure in the filter housing 2 is taken up radially outwardly through the connecting end 21 by means of the solid connecting head 12.

The reverse embodiment in which the connecting end 21 is positioned radially outwardly relative to the connecting head 12 so that the connecting end 21 radially engages the connecting head 12 externally is also possible, of course. In this case, the insertion projections 22 are not arranged on the outer side of the filter end 21 but on its inner side and the matching receiving slots or receiving projections are arranged on the outer side instead of the inner side of the connecting head 12. The connecting end 21 of the filter housing 2 in this case must be embodied somewhat stronger in order to be able to withstand the pressure load or must be secured by an additional securing element, for example, in the form of a lock nut or a connecting sleeve.

For connecting the filter 1 to the connecting head 12 the filter housing 2 is inserted in the insertion direction S into the connecting head 12 and afterwards turned by rotation of the filter housing 2 in the rotational direction D. The turning action causes the several parallel rows of insertion projections 22 on the connecting end 21 to engage with the several parallel rows of receiving slots 28 or receiving projections 29 on the connecting head 12. In this way, the bayonet connection is closed and the filter 1 is fixedly seated on or in the receiving head (connecting head) 12. In addition to this mechanical connection, sealing elements are provided, for example, O-rings, sealing lips or sealing rings that effect a pressure-tight sealing action.

For releasing the filter 1 from the receiving head 12, the filter housing 2 is rotated opposite to the rotational direction D and subsequently is removed in a direction opposite to the insertion direction S from the connecting head 12. The angle about which the filter housing 2 is rotated for closing or opening the bayonet connection depends on the length of the insertion projections and the matching receiving slots or receiving projections and can be, for example, between 5 degrees and 180 degrees, preferably between 10 degrees and 150 degrees, in particularly preferred between 45 degrees and 120 degrees.

The receiving slots or receiving projections and the insertion projections 22 can be arranged precisely in a perpendicular plane that is perpendicular to the insertion direction S. In this way, upon rotation of the filter housing 2 in the rotational direction D a stroke of the filter housing 2 in or opposite to the insertion direction S is not generated. In other embodiments, the receiving slots or the receiving projections and the insertion projections 22 may also be arranged at a slant to the perpendicular plane that is perpendicular to the insertion direction S so that upon rotation of the filter housing 2 in the rotational direction D, a stroke of the filter housing 2 in or opposite to the insertion direction S results, similar to the action of turning a screw with a thread.

According to a specific embodiment, the receiving slots or receiving projections and the insertion projections 22 are arranged at positive pitch so that the rotational movement upon closing the bayonet closure the spacing of the filter housing 2 to the connecting head 12 is reduced. With such a slightly slanted positive pitch of the ribs of the bayonet closure the surface pressure is increased upon mounting of the filter housing 2 similar to screwing a screw into a threaded bore; this can be beneficial for achieving pressure-tightly closed sealing elements.

In other embodiments it can also be provided that the receiving slots or receiving projections and the insertion projections 22 are arranged at a negative pitch so that upon rotational movement upon closing the bayonet closure the spacing of the filter housing 2 to the connecting head 12 is enlarged. This has accordingly the result that upon rotation of the filter housing 2 opposite to the rotational direction D the spacing of the filter housing 2 to the connecting head 12 is reduced. A slightly slanted negative pitch of the ribs of the bayonet closure thus causes in connection with the elastic axially acting sealing elements between filter housing 2 and connecting head 12 that, for releasing the filter 1, a force expenditure that progressively increases with the return movement is required; this counteracts an accidental opening of the closure, for example, as a result of vibrations.

In order to facilitate the attachment of the bayonet closure, it can be provided that the receiving slots, receiving projections or the insertion projections 22 at their ends facing one another, where they first engage one another when the insertion-rotation movement for closing the bayonet closure is carried, are provided with a ramp 23.

In order to prevent that the bayonet closure upon mounting of the filter 1 is overwound, a stop 24 can be provided that limits the maximum rotational angle in the rotation direction D after insertion of the connecting end 21 in the insertion direction S. According to a further advantageous feature, it can be provided that the bayonet closure is designed such that it cannot be opened or opened only with increased force expenditure when the filter housing 2 is under inner pressure. This can be realized, for example, by a self-locking configuration of the insertion projections 22 and of the corresponding receiving slots or receiving projections or a corresponding design of these elements with undercuts or locking noses, locking cams, or locking depressions, that require, for the purpose of demounting the filter 1, to first slightly press down the filter housing 2 in the insertion direction S before it can be rotated opposite to the rotational direction D.

Alternatively or additionally, the bayonet closure according to the invention can also be provided with a securing device (locking device) for securing the closed bayonet closure, in particular against automatic or accidental release by vibration or by handling errors. The securing or locking device prevents thus an accidental or automatic release or opening of the bayonet closure. Such a securing or locking device can comprise, for example, a mechanical locking system that secures the bayonet closure mechanically against rotation in the opening direction, i.e., opposite to the rotational direction D. A securing or locking device is advantageously designed such that upon closing of the bayonet closure it assumes automatically the secured position without the securing action having to be manually activated. In this way, handling errors are prevented.

A mechanical locking system can be realized, for example, by a pressure pin, a locking nose on a receiving slot, a receiving projection or an insertion projection 22, a snap-on element, a blocking pin, or an undercut; this encompasses, for example, a pressing and rotational return movement that requires, for the purpose of opening the bayonet closure, that the filter housing first be pressed slightly in the insertion direction S before it can be rotated opposite to the rotational direction D. Moreover, the securing or locking device can also be designed such that it secures or locks the bayonet closure as soon as the filter housing 2 is exposed to inner pressure.

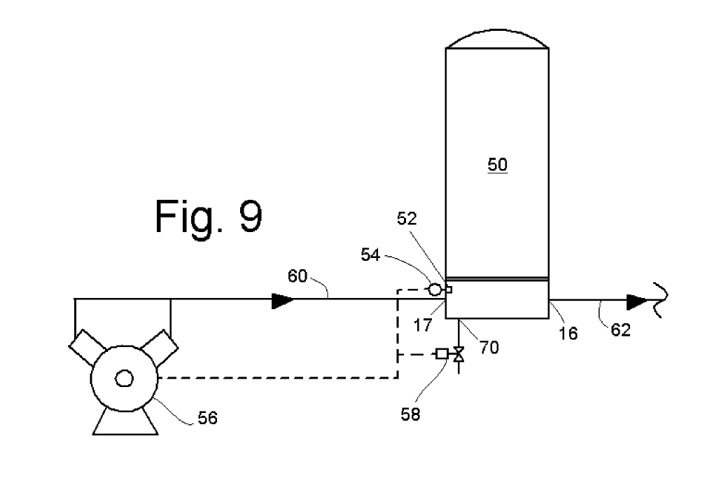

As shown schematically in FIG. 9, a filter housing and closure system 50 may be provided with a securing or locking device 52 can also have an electronic or electric signal transducer 54 for automatically switching off the pressure generation (for example, an air compressor 56) and/or for pressure relief (for example, by way of electrically activated valve 58 connected to drain connector 70) of the filter housing 2 (see FIG. 2); the signal transducer releases an appropriate signal as soon as the bayonet closure is opened, thereby depressurizing the filter housing.

In FIG. 2, the securing or locking device is realized by a pin 25 that is actuateable and acts in the radial direction. It is inserted into the connecting head 12 and is pressed with spring pretension against the connecting end 21 where it engages a corresponding locking cam of the connecting end 21 when the bayonet closure is closed in the rotational direction D (not illustrated). For removing the filter 1 first the pin 25 must be retracted in a direction opposite to the spring pretension in order to enable in this way a return rotation of the filter housing 2 in a direction opposite to the rotational direction D.

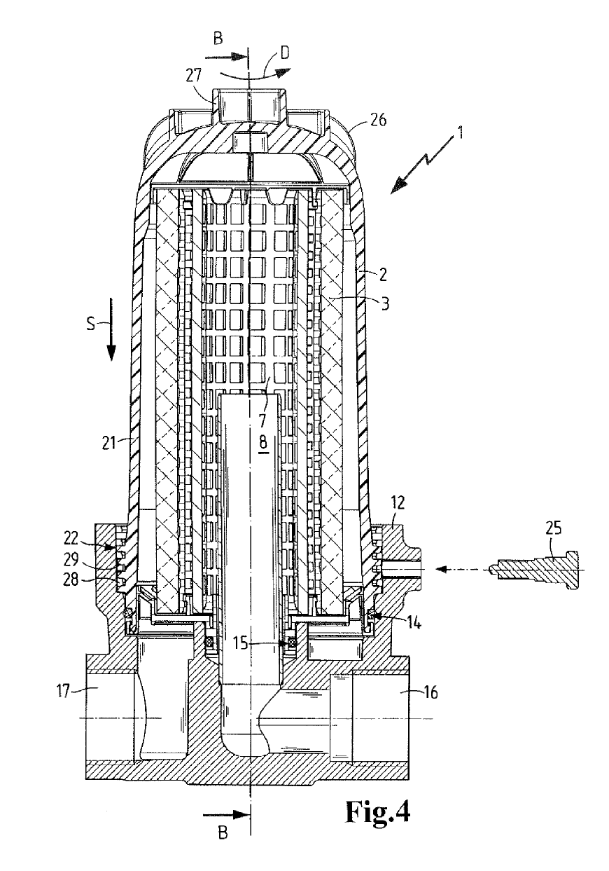

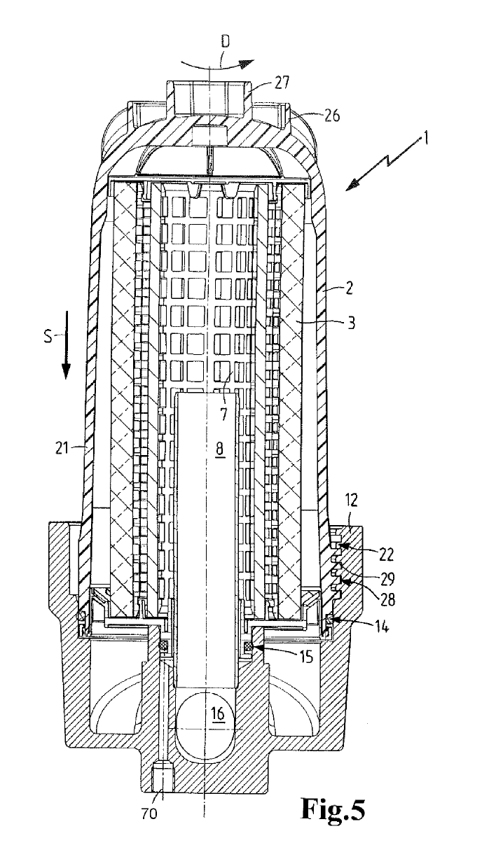

FIGS. 3 to 5 show an elevation view and two longitudinal section views of the filter 1 of FIG. 2 after mounting, i.e., the bayonet closure is closed. For facilitating mounting or demounting the filter housing 2 has a grip part 26 or a tool engagement element 27, for example, for a hexagon socket or hexagon head. In FIG. 5, the drainage connector 70 is illustrated.

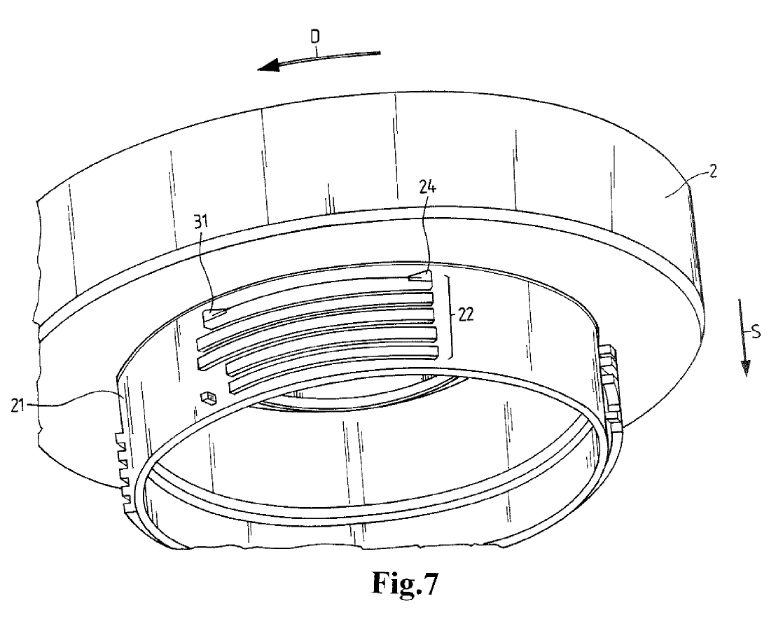

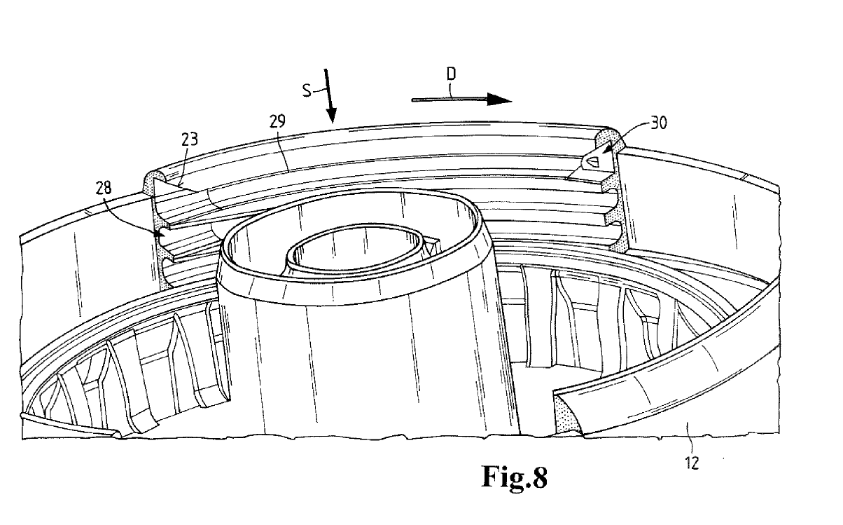

In FIGS. 6 to 8 a perspective partial view of a modified embodiment of the multi-row bayonet closure according to the invention is illustrated. In FIG. 6, the connecting end 21 and the connecting head 12 are illustrated, in FIG. 7 the connecting end 21, and in FIG. 8 the connecting head 12. In the Figures not only the insertion projections 22 but also the matching receiving slots 28 or receiving projections 29 are illustrated. In modification of the embodiment according to FIG. 2 the rotational direction D for closing the bayonet closure is clockwise instead of counterclockwise and the ramp 23 for facilitating the attaching action of the bayonet closure is not provided on the insertion projections 22 but arranged on the receiving slots 28 or receiving projections 29. The stop 24 is formed by a cam at the end of an insertion projection 22 and prevents further rotation of connecting end 21. The mechanical locking system for securing the closed bayonet closure comprises a locking element 32 and a cam 31.

The number of planes perpendicular to the insertion direction S in which parallel receiving slots 28, receiving projections 29 or insertion projections 22 are arranged, i.e., the number of rows of parallel ribs of the bayonet closure is advantageously between two and twelve, preferably between three and nine, particularly preferred between four and seven. In the illustrated embodiment of FIG. 2, four such parallel planes or rows have been selected; in the embodiment of FIG. 6 five such parallel planes or rows have been selected.

The planes perpendicular to the insertion direction S in which planes the receiving slots 28, receiving projections 29 or insertion projections 22 are arranged parallel to one another may have substantially the same spacing relative to one another. In order to ensure that only certain filters 1 fit on certain connecting heads 12 so that in this way it is prevented that wrong or unsuitable filters 1 are attached to the connecting head 12, which may cause damage or even dangerous situations, the bayonet closure may also be provided with a coding. Coding prevents that similar filter types are mixed up with one another in that a product-specific embodiment of the bayonet ribs is provided that can be varied, for example, with regard to height, width, length and number; this enables a large number of unique combinations. By variation of the number and segmentation of the bayonet ribs the carrying load of the bayonet closure can be varied also.

Coding of the bayonet closure can be done, for example, by the following measures: a) by means of spacings that vary relative to one another and/or number of planes perpendicular to the insertion direction S in which receiving slots 28, receiving projections 29 or insertion projections 22 are arranged parallel to one another; b) by means of the length and/or division of the interrupted segmentation of the receiving slots 28, receiving projections 29 or insertion projections 22; c) by means of the width (measured in the axial direction) or the height or depth (measured in radial direction) of the receiving slots 28, receiving projections 29, or insertion projections 22.

A further advantage of the closure system according to the invention, in particular in case of realization in customer-specific and/or coded embodiments, resides in that the filter housing 2 or the connecting end 21 can be manufactured of plastic material, for example, by injection molding, wherein in particular the use of short glass fibers or long glass fibers for high-strength materials is preferred in order to meet requirements with regard to pressure, temperature, and mechanical strength. By a segmented or modular configuration of the injection mold simply by exchanging the jaws of the mold which jaws shape the bayonet closure, a new product variant can be produced without requiring removal from the mold by rotation as in the case of threads. By means of a segmented embodiment of the mold, it is possible with one basic mold to produce different variants in a modular fashion. The manufacturing costs for a series of different bayonet closures are significantly reduced as a result of reduced tool costs.

The described closure system with multi-row bayonet closure can be used not only for seal-tight connection of filters to a connecting head but also in principle for producing any kind of mechanical connection with or without sealing function in particular when parts are to be connected to one another in a tight space in an inexpensive yet high-strength way. Such connections can be, for example, connections of round housing halves or pipelines.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A seal-tight filter closure system comprising:
a connecting end at an end face of a filter housing having a circular cylindrical shape;
a connecting head that matches said connecting end, wherein said connecting end is insertable or attachable in an axial insertion direction into or onto said connecting head and is connected positive-lockingly to said connecting head by an insertion-rotation movement;
wherein said connecting end and said connecting head have a bayonet closure at least at one connecting location;
wherein said bayonet closure comprises receiving slots or receiving projections on said connecting end or on said connecting head and further comprises matching insertion projections on said connecting head or on said connecting end, respectively, wherein said matching insertion projections engage said receiving slots or said receiving projections when said bayonet closure is closed;
wherein said receiving slots or said receiving projections and said insertion projections each are arranged substantially in a perpendicular plane extending perpendicularly to said insertion direction;
wherein said receiving slots or said receiving projections are elongated and, in a circumferential direction, do not extend completely around but, for enabling insertion or attachment, are segmented and interrupted by segmentation, wherein said receiving slots or said receiving projections are sequentially arranged in said insertion direction and are substantially parallel to one another;
wherein said insertion projections are sequentially arranged in said insertion direction; and
wherein said insertion projections are elongated and extend circumferentially and are interrupted by segmentation.

2. The filter closure system according to claim 1, wherein between two and ten, preferably between three and five, of said insertion projections are arranged sequentially in said insertion direction.

3. The filter closure system according to claim 1, wherein a total length of said insertion projections arranged within one of said perpendicular planes is between 5% to 90%, preferably between 10% and 80%, and particularly preferred between 30% and 70%, of a circumference of said connecting end or said connecting head.

4. The filter closure system according to claim 1, wherein said receiving slots or said receiving projections and said insertion projections are positioned precisely in said perpendicular plane, respectively.

5. The filter closure system according to claim 1, wherein said receiving slots or said receiving projections and said insertion projections are slanted relative to said perpendicular plane at a positive pitch so that upon rotational movement for closing said bayonet closure a spacing of said filter housing to said connecting head is reduced.

6. The filter closure system according to claim 1, wherein said receiving slots or said receiving projections and said insertion projections are slanted relative to said perpendicular plane at a negative pitch so that upon rotational movement for closing said bayonet closure a spacing of said filter housing to said connecting head is increased.

7. The filter closure system according to claim 1, wherein said receiving slots or said receiving projections or said insertion projections at ends thereof facing one another, at which ends first contact of said receiving slots or said receiving projections and said insertion projections with one another occurs upon closing of said bayonet closure by said insertion-rotation movement, are slanted in order to facilitate engagement of said bayonet closure.

8. The filter closure system according to claim 1, wherein between two and twelve, preferably between three and nine, particularly preferred between four and seven, of said perpendicular planes are provided.

9. The filter closure system according to claim 1, wherein said perpendicular planes are substantially positioned at identical spacing to one another.

10. The filter closure system according to claim 1, wherein said bayonet closure is coded by any of: varying a spacing of said perpendicular planes relative to one another, adjusting a number of said perpendicular planes, adjusting a length and/or a division of said segmentation, adjusting a width measured in said insertion direction of said receiving slots or said receiving projections or said insertion projections, adjusting a depth measured in a radial direction of said receiving slots or said receiving projections or said insertion projections.

11. The filter closure system according to claim 1, wherein said connecting end is positioned radially outwardly relative to said connecting head so that said connecting end engages said connecting head externally in the radial direction.

12. The filter closure system according to claim 1, wherein said connecting end is positioned radially inwardly relative to said connecting head so that said connecting head engages said connecting end externally in the radial direction.

13. The filter closure system according to claim 1, comprising a stop that prevents overwinding of said bayonet closure.

14. The filter closure system according to claim 1, wherein said bayonet closure is designed such that it cannot be opened or opened only with increased force expenditure when said filter housing is exposed to inner pressure.

15. The filter closure system according to claim 1, comprising a securing device for securing said bayonet closure particularly for preventing automatic release caused by vibrations or by handling errors.

16. The filter closure system according to claim 15, wherein said securing device comprises a mechanical locking system that secures said bayonet closure mechanically against opening.

17. The filter closure system according to claim 16, wherein said securing device upon closing said bayonet closure automatically assumes a securing position for said bayonet closure.

18. The filter closure system according to claim 16, wherein said mechanical locking system comprises a locking element selected from the group consisting of a pin that acts radially and is preferably radially actuated; a pressure pin; a locking cam on one of said receiving slots, said receiving projections or said insertion projections; a snap-on element; a blocking pin; and an undercut.

19. The filter closure system according to claim 15, wherein said securing device secures or locks automatically said bayonet closure when said filter housing is exposed to inner pressure.

20. The filter closure system according to claim 15, wherein said securing device comprises an electronic or electric transducer for automatically switching off pressure generation and/or for pressure relief of said filter housing, wherein said signal transducer emits a signal when said bayonet closure is opened.

21. A filter housing of a filter, said filter housing comprising a filter closure system according to claim 1.

22. A filter, comprising a filter housing and a filter element arranged in said filter housing, and further comprising a filter closure system according to claim 1.
